(19) United States
(12) Patent Application Publication
(10) Pub. No.: US 2007/0099452 A1
(43) Pub. Date: May 3, 2007

(54) Apparatus of attaching part

(75) Inventors: Shigeo Okada, Yokohama-shi (JP); Kazunori Machida, Yokohama-shi (JP); Oomi Airsaka, Yokohama-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: PIOLAX INC., Yokohama-shi (JP)

(21) Appl. No.: 11/589,981

(22) Filed: Oct. 31, 2006

(30) Foreign Application Priority Data
Nov. 1, 2005 (JP) 2005-317965
Mar. 9, 2006 (JP) 2006-064394

(51) Int. Cl. H01R 13/648

(52) U.S. Cl. 439/101

(57) ABSTRACT

A part mounting device for mounting a part to a generally rectangular angular hole formed in a mounting portion includes a main body having an elastic leg portion to be inserted in the angular hole and engaged with a pair of long sides of the angular hole and an insertion hole provided at at least non-bending side of the elastic leg portion, a cap having an insertion ledge which is configured to come into contact with at least non-bending side of the elastic leg portion when inserted in the insertion hole, the insertion ledge being disposed in a clearance between the elastic leg portion and at least one short side of the angular hole in a state in which the elastic leg portion is engaged with a pair of long sides of the angular hole. The elastic leg portion is not engaged with the angular hole when the bending direction of the elastic leg portion is arranged in parallel to the long sides of the angular hole, and the elastic portion is engaged with the angular hole when the bending direction is arranged in parallel to the short sides of the angular hole.

This application claims priority under 35 U.S.C. §119 to Japanese Patent Application No. 2006-064394 filed on Mar. 9, 2006, and 2005-317965 filed on Nov. 1, 2005, the entire disclosure of which is incorporated herein by reference in its entirety.

### Field of the Invention

The present invention relates, inter alia, to a part mounting device used in mounting a part, such as, e.g., an automobile part, to an mounting portion of a panel member, such as, e.g., an automobile panel member.

### BACKGROUND OF THE INVENTION

The following description sets forth the inventor's knowledge of related art and problems therein and should not be construed as an admission of knowledge in the prior art.

A sun visor is typically mounted on a ceiling wall portion above an upper part of a windshield of an automobile. As a mounting device for mounting such a sun visor on the ceiling wall portion, Japanese Unexamined Laid-open Patent Publication No. 2001-1758 (hereinafter referred to as “Patent Document”) discloses a mounting structure in which a sun visor is mounted on a ceiling wall portion via a holder to be engaged with a mounting hole formed in the ceiling wall portion. The holder is equipped with a base portion which can hold a shaft portion of the sun visor and a stem portion protruded from this base portion. The stem portion has a pair of elastic engaging ledges formed at the opposed sides of the stem portion via slits and protruded portions formed below each elastic engaging ledge. On the other hand, the mounting hole formed in the ceiling wall portion has a round hole portion for accommodating the stem portion and a pair of opposed diameter-expanded portions formed from the periphery of the round hole portion. Dented portions to be engaged with the protruded portions of the holder are formed in the inner periphery of the round hole portion.

When the stem portion of the holder is inserted into the round hole portion from the front side of the mounting hole, the elastic engaging ledges are bent inwardly by being pressed by the inner periphery of the round hole portion. When the elastic engaging ledges reach the rear side of the round hole portion, the engaging ledges engage with the rear side periphery of the round hole portion and the protruded portions also engage with the dented portions, whereby the holder can be mounted on the ceiling wall portion. The detachment of the holder from the ceiling wall portion can be performed by rotating the holder to move the elastic engaging ledges to the diameter expanded portions of the mounting hole and then pulling out therefrom.

In the case of the structure as disclosed by the aforementioned Patent Document, the protruded portion engages with the dented portions of the periphery of the round hole portion so as not to rotate the holder. However, since the protruded portions are formed below the elastic engaging ledges which can be elastically deformed, if strong rotation force is applied to the sun visor, the elastic engaging ledges are bent inwardly to thereby release the engaging between the dented portions and the protruded portions, causing a rotation of the holder, which may result in detachment of the holder from the mounting hole.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The present invention has been developed in view of the above-mentioned and/or other problems in the related art. The embodiments of the present invention significantly improve upon existing methods and/or apparatuses.

Among potential advantages, some embodiments provide a part mounting device easy in mounting/detaching operation and capable of assuredly mounting a part on a mounting portion without causing any rotation even if strong rotational force is applied.

According to one aspect of the present invention, a part mounting device is provided for mounting a part to a generally rectangular angular hole formed in a mounting portion. The device includes a main body having an elastic leg portion to be inserted in the angular hole and engaged with a pair of long sides of the angular hole and an insertion hole provided at least a non-bending side of the elastic leg portion. The device also includes a cap having an insertion ledge which is configured to contact at least the non-bending side of the elastic leg portion when inserted in the insertion hole, the insertion ledge being disposed in a clearance between the elastic leg portion and at least one short side of the angular hole in a state in which the elastic leg portion is engaged with a pair of long sides of the angular hole. The elastic leg portion is not engaged with the angular hole when the bending direction of the elastic leg portion is arranged in parallel to the long sides of the angular hole, and is engaged with the angular hole when the bending direction is arranged in parallel to the short sides of the angular hole.

Accordingly, in a state in which the insertion ledge of the cap is inserted in the insertion hole of the main body and the cap is attached to the main body, when the elastic leg portion of the main body and the insertion ledge of the cap are inserted into the angular hole with the bending direction of the elastic leg portion facing to the long sides of the angular hole, the elastic leg portions pass through the angular hole while being bent and engage with the inner periphery of the pair of long sides of the angular hole at the rear side thereof. Therefore, the part can be mounted on the mounting portion by one touch operation.

Also, since the insertion ledge is disposed in a clearance between the elastic leg portion and at least one of short side of the angular hole, and the insertion ledge is fitted to the corner portions of the angular hole, even if strong rotational force is applied to the part, the elastic leg portion and the insertion ledge are fitted in the angular hole and therefore the part would not rotate therein, and the elastic leg portion can be prevented from being pulled out from the angular hole due to the bending of the elastic leg portion.

Furthermore, when it is required to detach the mounting device, by pulling out the insertion ledge from the angular hole to detach the cap from the main body, a clearance is generated between the elastic leg portion and the short side of the angular hole. Therefore, by twisting the main body in this state, the engaging ledges of the elastic leg portion are rotated, so that the bending direction can be directed to the direction parallel to the long sides of the angular hole. Thereby, since the engagement of the elastic leg portion to the angular hole is released, the main body can be removed easily by pulling out the elastic leg portion from the angular hole.

According to this mounting device, since it is only required to form the angular hole having a rectangular shape in a mounting member, the cost reduction can be attained as compared with the case in which a mounting hole having a special shape as disclosed by the aforementioned Patent Document is formed.

According to a another aspect of the present invention, the insertion hole of the main body is provided at both non-bending sides of the elastic leg portion, and the cap is provided with a pair of generally parallel insertion ledges to be inserted in the pair of insertion holes. The insertion ledges are fitted in the insertion holes with the insertion ledges in contact with on both non-bending sides of the elastic leg portion and fitted to four corner portions of the angular hole. Therefore, the part can be secured without causing any displacements. In cases where the part is required to be detached, when the insertion ledges of the cap are pulled out from the angular hole to remove the cap from the main body, a clearance is generated at both non-bending sides of the elastic leg portion. Thus, the main body can be easily twisted so that the bending direction of the elastic leg portion becomes in parallel to the long side of the angular hole.

According to another aspect of the present invention, the elastic leg portion has a stem portion upwardly protruded from the main body, and an engaging ledge extended from a tip of the stem portion toward the main body in an anchor shaped manner, and the insertion ledge protrudes higher than the elastic leg portion when the cap is attached to the main body.

In this case, for example, because the insertion ledge protrudes higher than the elastic leg portion when the cap is attached to the main body, the elastic leg portion can be protected from an external impact, etc., thereby preventing breakage of the elastic leg portion, which in turn makes it possible to maintain the engaging force of the elastic leg portion to the angular hole.

According to another aspect of the present invention, the main body has a slit communicated with the insertion hole and penetrating the main body, the elastic leg portion has a stem portion including a pair of wall portions extended from opening edge portions of the slit via a clearance and connected at tip ends thereof, and engaging ledges protruded sideward from the stem portion, the cap has at least one insertion ledge to be inserted in the insertion hole of the main body, and a connection wall extended from the insertion ledge, the connection wall being to be inserted in the slit and a clearance between the wall portions of the stem portion, and an engaging portion for engaging the wall portions of the stem with the connection wall when the connection wall is inserted in the clearance of the wall portions of the stem portion is provided at an inner surface of the wall portion of the stem portion located at the clearance and the connection wall.

In this case, for example, when the cap is pushed into the main body until the insertion ledge of the cap is disposed at the non-bending side of the elastic leg portion with the insertion ledge of the cap in alignment with the insertion hole of the main body, the connection wall of the cap is inserted in the clearance of the wall portions of a stem portion through the slit of the main body. The cap can be attached to the main body by the engagement of the engaging portion formed between the wall portions of the stem portion and the connection wall.

When the elastic leg portion is inserted into the angular hole with the bending direction of the elastic leg portion facing to the long sides of the angular hole, the elastic leg portion passes through the angular hole and engages with the inner periphery of the pair of long sides of the angular hole at the rear side thereof. Thus, the part can be mounted to the mounting portion.

Moreover, when the part is required to be detached, by strongly pulling the cap away from the main body with a tool, etc., the engaging by the engaging portion can be released. Thus, the insertion ledge and the connection wall of the cap can be pulled out. When the cap is pulled out from the main body as mentioned above, a clearance is generated between the elastic leg portion and the angular hole, as mentioned above, In this state, by pulling out the elastic leg portion from the angular hole with the elastic leg portion facing to the short sides of the angular hole by rotating the main body, the part can be removed from the mounting portion.

For example, because the cap is prevented from being pulled out by the engaging portion formed between the connection wall of the cap and the wall portion of the stem portion by inserting the connection wall of the cap in the clearance of the wall portions of the stem portion, at the time of pulling out the cap to detach the part, the connection wall will be pulled out while being guided by the clearance of the wall portions and the slit of the stem portion. Consequently, even in situations where the cap is forcibly pulled out with large force using a tool T. etc., only a load in the engaging direction (i.e., the direction of pushing the cap into the main body, or the direction of pulling out the cap from the main body) is applied to the engaging portion. Therefore, possible damages to the engaging portion can be effectively prevented. Accordingly, the hook can be again mounted to the mounting portion, without requiring any exchange of the part.

According to another aspect of the present invention, the insertion holes of the main body are provided at both non-bending sides of the elastic leg portion, the slit connects the insertion holes in an H-shaped manner in cross-section, the slit penetrating the main body, and the cap has a pair of parallel insertion ledges to be inserted in the pair of insertion holes of the main body, and a connection wall which connects thee insertion ledges, the connection wall being inserted in the slit and the clearance between the wall portions of the stem portion.

Therefore, since the pair of insertion ledges provided to the cap are connected by the connection wall, the separation of the insertion ledges will not occur. Furthermore, when the insertion ledges are inserted in the insertion holes of the main body, the insertion ledges can be brought into contact with both non-bending sides of the elastic leg portion. Consequently, at the time of inserting the elastic leg portion and the insertion ledges in the angular hole, each insertion ledge can be prevented from getting stuck in the angular hole. Also, since each insertion ledge is hard to bend, the mounting strength of the part can be enhanced.

According to another aspect of the present invention, the engaging portion includes protruded portions formed on inner surfaces of the wall portions of the stem portion facing the clearance of the wall portions at a longitudinal intermediate portion of the clearance, and an engaging hole formed in the connection wall of the cap, whereby the protruded portions are engaged with the engaging hole when the connection wall of the cap is inserted in the clearance of the wall portions of the stem portion.

In this case, for example, when the connection wall of the cap is inserted in the clearance of the wall portions of the stem portion, the protruded portion formed on the inner surface of the wall portion of the stem portion located in the clearance of the wall portions engages with the engaging hole formed on the connection wall to thereby prevent the cap from being pulled out. Moreover, when the cap is strongly pulled with a tool, etc., the engagement between the protruded portion and the engaging hole will be released. Thus, the cap can be pulled out. In this case, for example, since the protruded portion is formed at the longitudinal intermediate of the clearance of the wall portions of the stem portion, the wall portions of the stem can be easily bent, resulting in an easy insertion and detachment of the cap.

According to another aspect of the present invention, the main body has a holding portion for holding a shaft portion of a sun visor.

In this case, for example, by fitting the shaft portion of the sun visor for automobiles in the holding portion, the shaft portion of the sun visor can be held by the ceiling wall portion as an mounting portion by one-touch operation.

According to another aspect of the present invention, the main body has a columnar portion with a diameter expanded tip portion, and a hook extended from a vicinity of the columnar portion, insertion holes for inserting the insertion ledges are formed at both sides of the columnar portion, a slit is formed so as to cross a central portion of the columnar portion, and the cap is inserted along an axis of the columnar portion and put on an end of the columnar portion.

In this case, for example, since the insertion ledge and the connection wall of the cap are inserted along the axis of the columnar portion, the insertion ledge and the connection wall are integrally connected to the columnar portion, resulting in a good appearance. A rope, a net, etc., for securing a load in a luggage compartment can be hooked on the columnar portion of the hook, and a shopping bag, etc., can be hung on the hook portion. With this device, since the insertion ledge is fitted in the angular hole, it is possible to mount the device so as not to rotate the hook.

In summary, according to some aspects of the present invention, after attaching the cap to the main body, by inserting the elastic leg portion of the main body and the insertion ledge of the cap into the angular hole with the bending direction of the elastic leg portion facing to the long sides of the angular hole, the elastic leg portion engages with the inner periphery of the pair of long sides at the rear side of the angular hole, and the insertion ledge of the cap is arranged in the clearance formed between the elastic leg portion and at least one short side of the angular hole with the insertion ledge fitted to the angle portion of the angular hole. Therefore, the device would not rotate even if strong rotational force is applied to the part, which assuredly prevents the elastic leg portions from being pulled out from the angular hole. Also, the mounting of the device can be performed by one-touch operation.

Also, if it is required to detach the part, by pulling out the insertion ledges of the cap from the angular hole to detach the cap from the main body, a clearance is generated between the elastic leg portion and at least one short side of the angular hole. Therefore, by turning the main body, so that the bending direction is directed to the direction parallel to the long sides of the angular hole, the engagement of the elastic leg portion to the angular hole is released. Therefore, the main body can be removed easily by pulling out the elastic leg portion from the angular hole.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, wherein:

FIG. 1 is an exploded perspective view showing an embodiment of the present invention applied to a mounting device for a sun visor holder;

FIG. 2 shows a main body constituting the sun visor holder, wherein FIG. 2A is a front view thereof, FIG. 2B is a right side view thereof, FIG. 2C is a top view thereof, and FIG. 2D is a bottom view thereof;

FIG. 3 shows a cap constituting the sun visor holder, wherein FIG. 3A is a front view thereof, FIG. 3B is a right side view thereof, and FIG. 3C is a bottom view thereof;

FIG. 4 is a perspective view showing the sun visor holder before mounting it to a ceiling wall portion;

FIG. 5 shows a state in which the sun visor holder is mounted to the ceiling wall portion, wherein FIG. 5A is a front view thereof, and FIG. 5B is a right side view thereof;

FIG. 6 is a plan view showing the state in which the sun visor holder is mounted on the ceiling wall portion;

FIG. 7 is an exploded perspective view of another embodiment in which the present invention is applied to a mounting device for a luggage compartment hook;

FIG. 8 shows a main body of the luggage compartment hook, wherein FIG. 8A is a front view thereof, FIG. 8B is a right side view thereof, FIG. 8C is a left side view thereof, and FIG. 8D is a top view thereof;

FIG. 9 is an enlarged cross-sectional view showing a principal portion of the main body of the luggage compartment hook;

FIG. 10 is a cap for the luggage compartment hook, wherein FIG. 10A is a front view thereof, FIG. 10B is a plan view thereof, and FIG. 10C is a left side view thereof;

FIG. 11 is a perspective rear side view of the state in which a cap is attached to the main body of the luggage compartment hook; and

FIG. 12 is a cross-sectional view showing the state in which the luggage compartment hook is mounted to the luggage compartment wall portion.

### DETAILED DESCRIPTION OF THE INVENTION

In the following paragraphs, some embodiments of the invention will be described by way of example and not limitation. It should be understood based on this disclosure that various other modifications can be made by those in the art based on these illustrated embodiments.

Hereinafter, an embodiment of the part mounting device according to the present invention will be explained.

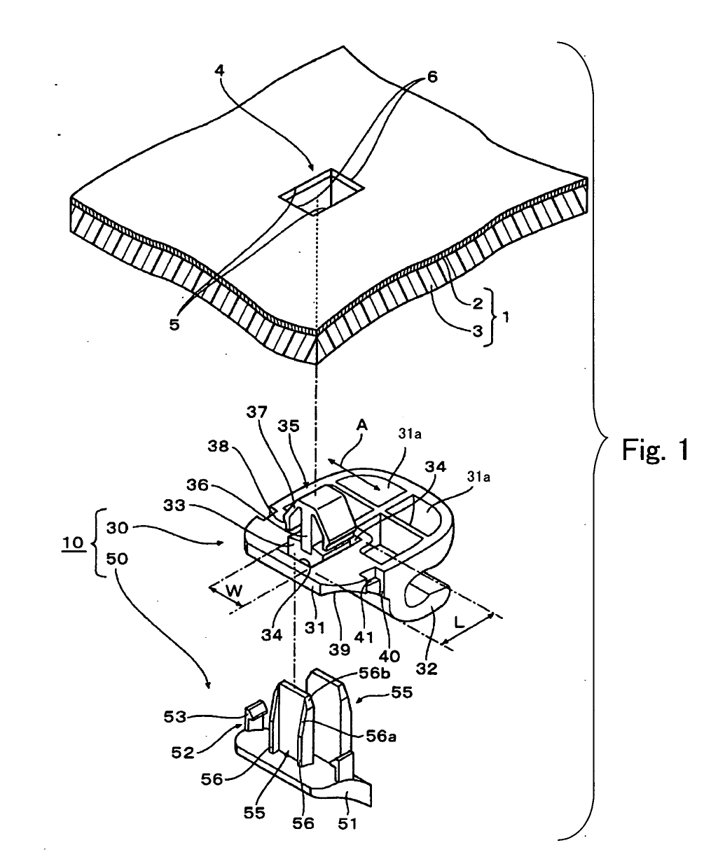

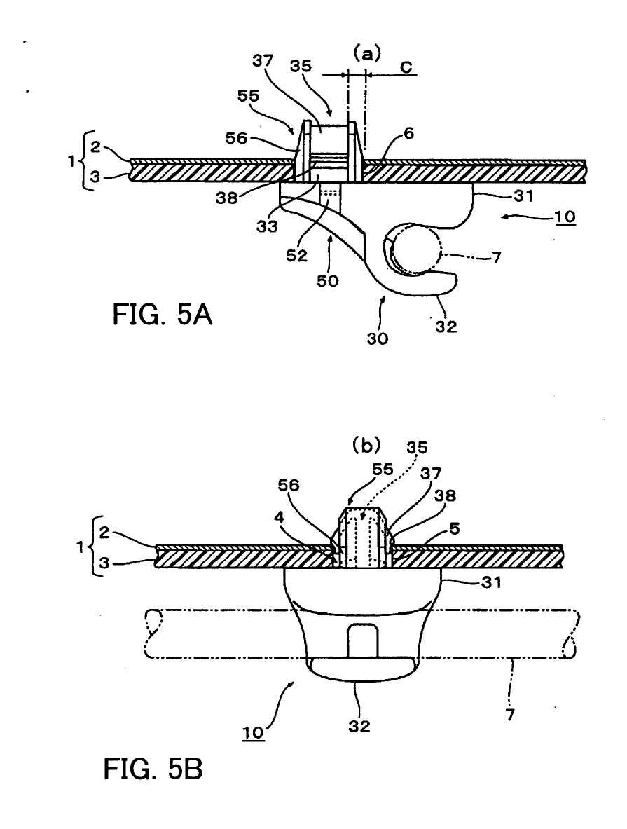

FIGS. 1 to 6 show one embodiment in which the present invention is applied to a mounting device for a sun visor holder. In this embodiment, as shown in FIGS. 1 and 5, a ceiling wall portion 1 located above a windshield of an automobile corresponds to an mounting portion as set forth in the present invention. The sun visor holder 10 as a part as set forth in the present invention is mounted on the ceiling wall portion 1.

The ceiling wall portion 1 in this embodiment includes a panel member 2 and a trim member 3 attached to the lower surface of the panel member 2. At the predetermined portion of the ceiling wall portion 1, an angular hole 4 having a generally rectangular shape surrounded by long sides 5 and 5 and short sides 6 and 6 perpendicular to these long sides 5 and 5 is formed.

The sun visor holder 10, which is a part as set forth in the present invention (hereinafter simply referred to as “holder 10”), includes a main body 30 which has an elastic leg portion 35 to be engaged with the angular hole 4, and a cap 50 to be attached to the main body 30, as main components.

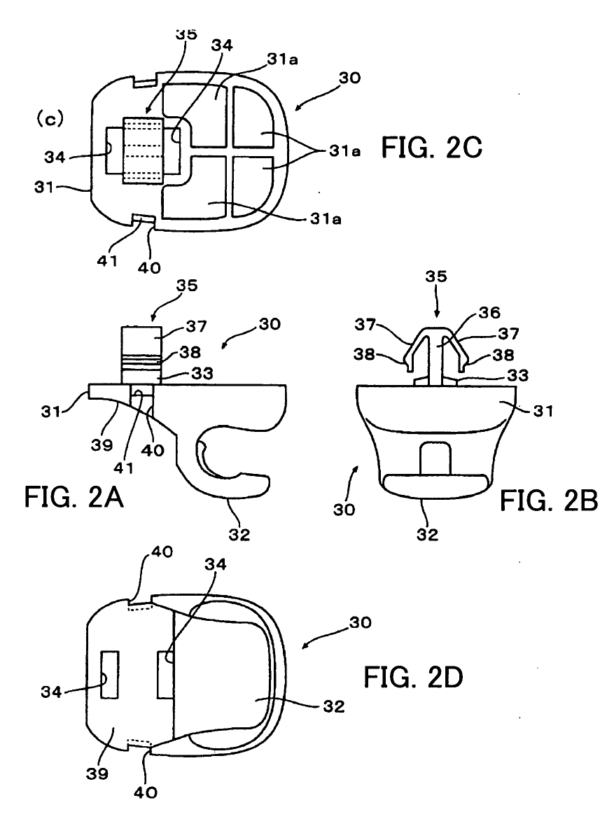

Also referring to FIG. 2, the main body 30 is generally rectangular in shape, and has a base portion 31 which comes into contact with the trim member 3 of the ceiling wall portion 1, and a holding portion 32 protruded from the lower surface of the base portion 31 into a C-shape in cross-section for detacheably holding a shaft portion 7 (see FIG. 5) of the sun visor (not illustrated). In this embodiment, the holding portion 32 is formed into a C-shape for holding the Up end portion of the shaft portion 7 of the sun visor, but not limited to this. The holding portion 32 can be configured so as to rotatably hold the basal end of the shaft portion 7 of the sun visor. For example, it can be configured such that the basal end of the shaft portion of the sun visor has a spherical expanded portion and the holding portion is an adjustable joint having a spherical dented portion which can hold the spherical expanded portion in a pivotally movable manner.

The base portion 31 has a plurality of material saving dented portions 31a formed at the longitudinal one side of the upper surface (a surface which comes into contact with the trim member 3 of the ceiling wall portion 1) and an elastic leg portion 35 protruded via a pedestal portion 33 at the side opposite to the dented portions 31a. This elastic leg portion 35 has a stem portion 36 which is a plate-shaped member having a wide width along the longitudinal direction of the base portion 31 and upwardly protruded from the pedestal portion 33, and a pair of engaging ledges 37 and 37 extended in the shape of an anchor from the tip of the stem portion 36 toward the pedestal portion 33 and having the same width as that of the stem portion 36. At the Up end portions of the engaging ledges 37 and 37, engaging stepped portions 38 and 38 are formed, which will be served as engaging portions to be engaged with the long sides 5 and 5 of the angular hole 4 of the ceiling wall portion 1. The engaging ledges 37 and 37 of the elastic leg portion 35 are configured so as to be inwardly bent with respect to the width direction of the main body 30 at the time of inserting them into the angular hole 4. This direction will be defined as a bending direction A of the elastic leg portion 35 (see FIG. 1).

The width of the elastic leg portion 35 in the bending direction A is set to be longer than the length W of the short side 6 of the angular hole 4, but shorter than the length of the long side 5 thereof. Accordingly, when the bending direction A of the elastic leg portion 35 is aligned with a direction perpendicular to the long sides 5 and 5, the elastic leg portion 35 can be engaged with the long sides 5 and 5 of the angular hole 4. On the other hand, when the bending direction A of the elastic leg portion 35 is aligned with a direction parallel to the short sides 6 and 6, the elastic leg portion 35 cannot be engaged with the angular hole 4.

As best shown in FIG. 2A, provided at the lower surface of the base portion 31 below the elastic leg portion 35 is a cap mounting portion 39 whose thickness increases from the tip end portion of the base portion 31 toward the basal end portion of the holding portion 32. At both sides of this cap mounting portion 39, a pair of guide grooves 40 and 40 are formed so as to extend in the thickness direction of the base portion 31 (see FIGS. 2A and 2C). At the upper part of each of the guide grooves 40 and 40, an engaging stepped portion 41 is formed (see FIG. 2A). An engaging ledge 52 of the cap 50, which will be mentioned later, is fitted in the guide groove 40, and the hook portion 53 formed at the tip of the engaging ledge 52 engages with an engaging stepped portion 41.

Moreover, a pair of insertion holes 34 and 34 are formed in the base portion 31 at the positions adjacent to the pedestal portion 33 on which the elastic leg portion 35 is formed and at both non-bending direction sides of the engaging ledges 37 and 37 of the elastic leg portion 35, i.e., in this embodiment, at both sides of the elastic leg portion 35 perpendicular to the bending direction A of the elastic leg portion 35.

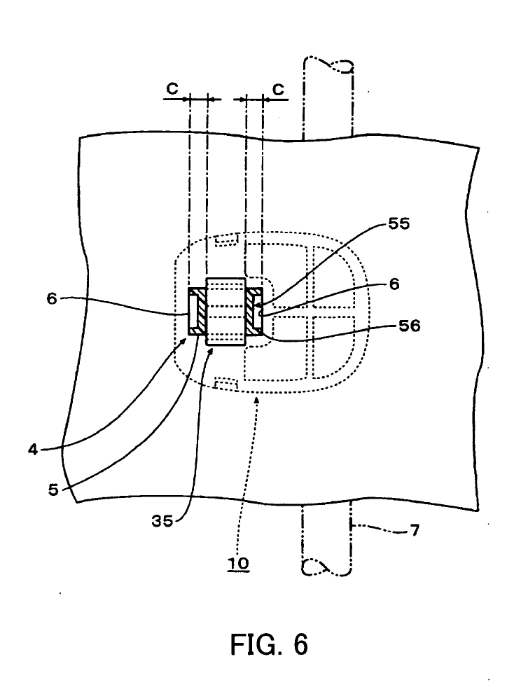

The pair of insertion holes 34 and 34 are each formed to have approximately the same size as the size of the angular hole 4. In detail, as shown in FIG. 1, the distance L between these insertion holes 34 and 34 is formed to have the same length of the long side 5 of the angular hole 4, and the length W of each insertion hole 34 is formed to have the same length of the short side 6 of the angular hole 4. In a state in which the engaging stepped portions 38 and 38 of the elastic leg portion 35 are engaged with generally the central portions of the respective long sides 5 and 5 of the angular hole 4, a clearance C as shown in FIGS. 5A and 6 is formed between each short side 6 of the angular hole 4 and the elastic leg portion 35.

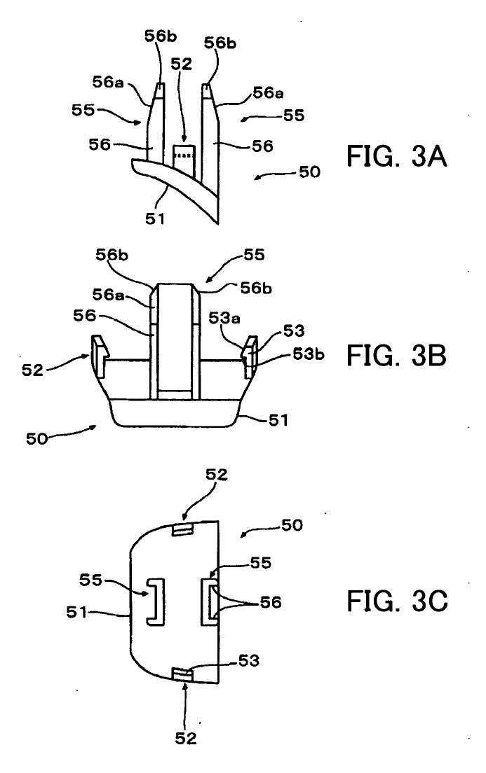

To the main body 30, the cap 50 as shown in FIGS. 3A to 3C is to be attached. This cap 50 has a bottom plate 51 having a shape which can fits on the cap mounting portion 39 of the main body 30. From both width direction sides of the top surface (the surface which comes into contact with the cap mounting portion 39) of the bottom plate 51, a pair of engaging ledges 52 and 52 to be fitted in the guide grooves 40 and 40 of the main body 30 are upwardly protruded. At the Up inner sides of the engaging ledges 52 and 52, hook portions 53 and 53 are protruded in an opposed manner. The hook portion 53 has a tapered surface 53a which gradually decreases in thickness toward the Up end to secure the insertion operation of the engaging ledge 52, and an engaging portion 53b to be engaged with the engaging stepped portion 41 formed in the guide groove 40.

On the width direction center of the upper surface of the bottom plate 51, a pair of insertion ledges 55 and 55 are upwardly protruded in parallel with each other at a distance capable of being inserted into the insertion holes 34 and 34 of the main body 30 with the same height. Moreover, each insertion ledge 55 has, at its width direction sides, outwardly protruded ribs 56 and 56. Each rib 56 has a tapered surface 56a gradually decreased in height from the approximately half of the height toward the upper end, so that the insertion ledge 55 can be easily inserted into the insertion hole 34 of the main body 30. Furthermore, at the outside upper ends of each rib 56, tapered faces 56b are formed to facilitate the insertion of the insertion ledge 55 into the insertion hole 34 of a main body 30. Furthermore, the distance between the insertion ledges 55 and 55 including the ribs 56 coincides with the distance L between the insertion holes 34 and 34, and the width of each insertion ledge 55 coincides with the width W of the insertion hole 34.

In this embodiment, the insertion ledge 55 is provided with ribs 56 at its both sides. The insertion ledge 55, however, is not limited to this structure, and can be in any form so long as the insertion ledge 55 can be inserted into the insertion hole 34 and fitted to the short side 6 of the angular hole 4.

The insertion ledges 55 and 55 are inserted into the insertion holes 34 and 34 at the time of attaching the cap 50 to the main body 30. The insertion ledge 55 protruded from the insertion hole 34 of the main body 30 is inserted into and disposed in the clearance C formed between the short side 6 of the angular hole 4 and the elastic leg portion 35. At this time, a total of four ribs 56 and 56 formed at both sides of each insertion ledge 55 contact with four corner portions of the angular hole 4.

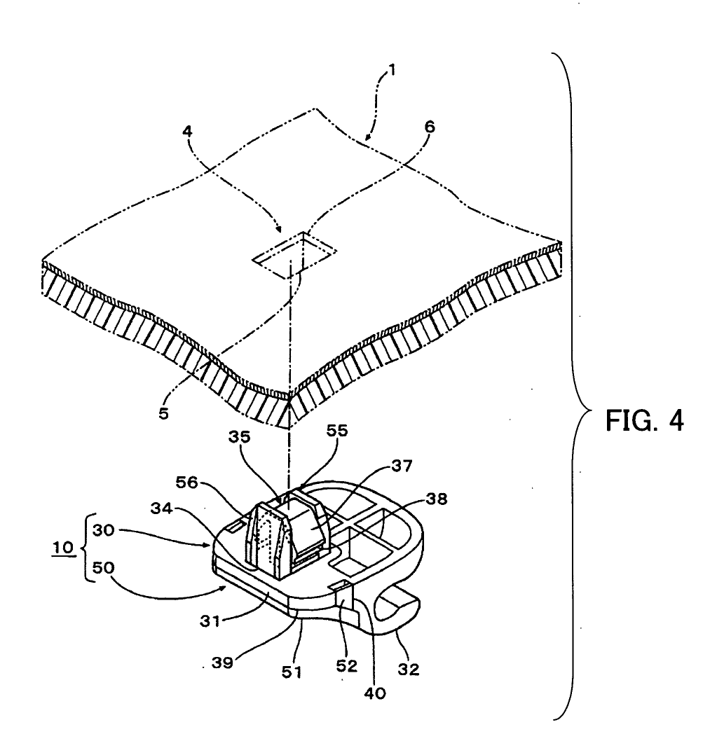

Furthermore, as shown in FIGS. 4, 5A and 5B, in a state in which the cap 50 is attached to the main body 30, the insertion ledges 55 and 55 protrude higher than the elastic leg portion 35.

Next, a method of mounting the holder 10 to the ceiling wall portion 1 is explained.

As shown in FIG. 1, initially, the cap 50 is pushed against the main body 30 from the lower surface side of the main body 30 with the insertion ledges 55 and 55 of the cap 50 in alignment with the insertion holes 34 and 34. As a result, the insertion ledges 55 and 55 are inserted in the insertion holes 34 and 34. At the same time, the engaging ledges 52 and 52 also are inserted in the guide grooves 40 and 40 while the tapered surface 53a of the hook portion 53 is pressed and bent outwardly. As the cap 50 is further pushed against the main body 30, the insertion ledges 55 and 55 protrude from the insertion holes 34 and 34, and the hook portions 53 of the engaging ledges 52 reach the engaging stepped portions 41 and 41. Thus, the engaging ledges 52 and 52 are engaged with the engaging stepped portions 41 and 41 by the elastic return. As a result, as shown in FIG. 4, the cap 50 is attached to the main body 30. At this time, the insertion ledges 55 and 55 protruding from the insertion holes 34 and 34 of the main body 30 contact the non-bending sides of the elastic leg portion 35.

As shown in FIG. 4, the broad surfaces of the engaging ledges 37 and 37 of the elastic leg portion 35 and the side portions of the insertion ledges 55 and 55 are arranged so as to face the long sides 5 of the angular hole 4 of the ceiling wall portion 1. That is, in a state in which the bending direction A of the elastic leg portion 35 is adjusted so as to face the long sides 5 and 5 of the angular hole 4, the elastic leg portion 35 of the holder 10 is inserted into the angular hole 4 from the front side of the ceiling wall portion 1 to which the trim member 3 is attached. Then, the engaging ledges 37 and 37 are pressed by the periphery of the long sides 5 and 5 of the angular hole 4 to be bent inwardly in the bending direction A. When the engaging stepped portions 38 and 38 reach the long sides 5 and 5 of the angular hole 4 of the panel member 2, the engaging ledges 37 and 37 return elastically, causing an engagement of the engaging stepped portions 38 and 38 with the inner periphery of the long sides 5 and 5. In this way, as shown in FIG. 5A and 5B, the upper surface of the main body 30 is in contact with the trim member 3 located at the front surface of the ceiling wall portion 1, and the elastic leg portion 35 is engaged with the panel member 2 located at the rear side of the ceiling wall portion 1. Thus, the holder 10 can be fixedly mounted on the ceiling wall portion 1. Thus, in a state in which the cap 50 is previously attached to the main body 30, by pushing the holder 10 into the angular hole 4 in an aligned manner, the holder 10 can be mounted on the ceiling wall portion 1 through one-touch operation.

By fitting the shaft portion 7 of the sun visor in the holding portion 32 of the main body 30, as shown in FIGS. 5A and 5B, the shaft portion 7 of the sun visor can be held by the ceiling wall portion 1, which is a mounting portion, through one-touch operation.

In a state in which the holder 10 is held by the ceiling wall portion 1 as mentioned above, the insertion ledges 55 and 55 of the cap 50 are disposed in the clearances C formed between the elastic leg portions 35 and 35 and the short sides 6 of the angular hole 4, and the insertion ledges 55 are fitted to the corner portions of the angular hole 4 (see FIG. 5A and FIG. 6). Therefore, even if a strong rotational force is applied to the holder 10, since the elastic leg portion 35 and the insertion ledges 55 and 55 are fitted in the angular hole 4, the holder 10 will not rotate. Thus, it becomes possible to prevent the bending of the elastic leg portion 35 and the detaching of the elastic leg portion 35 from the angular hole 4.

Furthermore, when it is required to detach the holder 10 from the ceiling wall portion 1, the cap 50 can be detached from the main body 30 by releasing the engagement of the hook portions 53 and 53 of the engaging ledges 52 and 52 of the cap 50, pulling out the engaging ledges 52 and 52 from the guide grooves 40 and 40, and pulling out the insertion ledges 55 and 55 from the angular hole 4. Consequently, clearances C will be generated between the elastic leg portions 35 and the short sides 6 and 6 of the angular hole 4. In this state, by rotating the main body 30, the engaging ledges 37 and 37 of the elastic leg portion 35 are rotated, so that the bending direction A can be aligned with a direction parallel to the long sides 5 and 5 of the angular hole 4. Thereby, since the engagement of the elastic leg portion 35 with the angular hole 4 is released, the main body 30 can be removed easily by pulling out the elastic leg portion 35 from the angular hole 4.

According to this mounting device, for example, since it is only required to form the angular hole 4 having a rectangular shape as shown in FIG. 1 in the ceiling wall portion 1 of an automobile, the cost reduction can be attained as compared with the case in which the mounting hole having a special shape as disclosed by the aforementioned Patent Document is formed.

Moreover, in the aforementioned holder 10, a pair of insertion holes 34 and 34 are formed at both non-bending sides of the elastic leg portion 35, and a pair of insertion ledges 55 and 55 to be inserted in the insertion holes 34 and 34 are formed on the cap 50. Thereby, as shown in FIG. 6, the pair of insertion ledges 55 and 55 come into contact with both the non-bending sides of the elastic leg portion 35, and inserted in the angular hole 4 so as to be fitted to the four corner portions of the angular hole 4. As a result, the holder 10 can be firmly fixed to the angular hole 4 without causing any play therebetween. When the cap 50 is removed from the main body 30 by pulling out the insertion ledges 55 and 55 from the angular hole 4, clearances C will be generated at both the non-bending sides of the elastic leg portion 35. This allows an easy rotation of the main body 30 so that the bending direction A of the elastic leg portion 35 becomes parallel to the long sides 5 of the angular hole 4, resulting in an easy detachment of the holder 10 from the ceiling wall portion 1.

Furthermore, in the fixed state of the holder 10, since a total of four ribs 56 provided at both sides of each insertion ledge 55 of the cap 50 locally come into contact with four corner portions of the angular hole 4, even if very strong rotational force is applied to the holder 10, the holder 10 can be stably secured.

Moreover, in the aforementioned mounting device, as shown in FIG. 4 and FIGS. 5A and 5B, it is constituted such that the insertion ledges 55 and 55 protrude higher than the elastic leg portion 35 when the cap 50 is attached to the main body 30. Therefore, the elastic leg portion 35 can be effectively protected from an external impact, etc., which in turn can prevent the breakage of the elastic leg portion 35, etc. Thus, the engaging force of the elastic leg portion 35 to the angular hole 4 can be better maintained.

The end portion of the base portion 31 of the main body 30 and the end portion of the bottom plate 51 of the cap 50 can be integrally formed such that the main body 30 and the cap 50 are connected via a think hinge portion, etc., whereby the insertion ledges 55 and 55 can be inserted into the insertion holes 34 and 34 by pivotally moving the cap 50 relative to the main body 30.

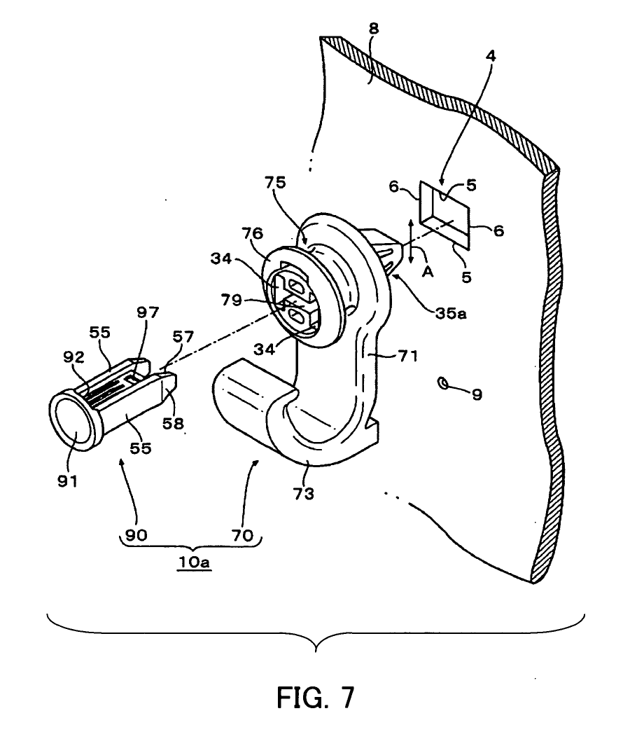

FIGS. 7 to 12 show another embodiment in which the present invention is applied to a mounting device for a luggage compartment hook. In the following explanation, the explanation of the portions substantially the same as those of the aforementioned first embodiment will be omitted by allotting the same reference numeral.

This luggage compartment hook 10a is equipped with a main body 70 and a cap 90 to be attached to the main body 70. This luggage compartment hook 10a corresponds to a part as set forth in the present invention.

In this embodiment, the luggage compartment wall portion 8 vertically extended from the bottom surface of the load space located behind a rear seat of an automobile corresponds to a mounting portion as set forth in the present invention. It is configured such that the luggage compartment hook 10a (hereinafter simply referred to as “hook 10a”) is mounted on the luggage compartment wall portion 8. This hook 10a can be used to hook a rope, a net, etc., for securing a load disposed in a luggage compartment or to hang a shopping bag, etc.

The luggage compartment wall portion 8 is provided with a rectangular shaped angular hole 4 similar to the aforementioned embodiment with the long sides 5 and 5 arranged in parallel to the bottom surface of the luggage compartment (not illustrated). Furthermore, a positioning hole 9 is formed below the center of the long side 5 of the angular hole 4 at a certain distance. In this positioning hole 9, a positioning pin 72 of the main body 70, which will be mentioned later, is inserted to attain the positioning of the hook 10a.

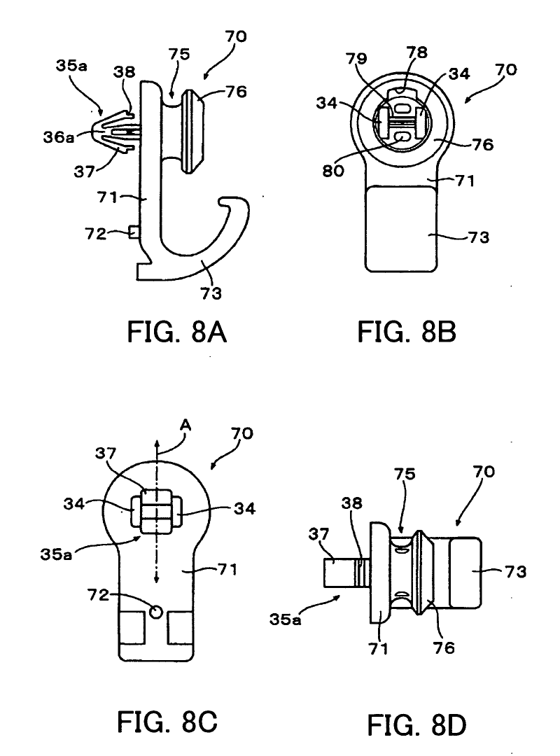

The main body 70 of the hook 10a is explained with reference to FIGS. 7 to 9. The main body 70 is a long plate extended in one direction, and has a base portion 71 which comes into contact with the luggage compartment wall portion 8. The longitudinal one end portion of the base portion 71 is formed into a circular shape slightly enlarged in diameter, and an elastic leg portion 35a is protruded from the contacting surface of the enlarged circular portion so that the bending direction A is in parallel to the longitudinal direction of the base portion 71. Furthermore, a positioning pin 72 to be inserted into the positioning hole 9 is protruded from the contacting surface of the base portion 71 which comes into contact with the luggage compartment wall portion 8 at a portion near the other longitudinal end portion of the base portion 71 (see FIG. 8A). Furthermore, from the other longitudinal end of the base portion 71, a hook portion 73 having a generally J-shape as seen from the side is protruded. To this hook portion 73, a handle portion of a shopping bag, etc., are hooked to thereby hang a shopping bag, etc. The hook portion 73 is not limited to a J-shaped hook portion, and can be in any form, such as, e.g., an L-shaped hook portion, or a hook extended obliquely upwardly from the end portion of the base portion 71, but not limited to them.

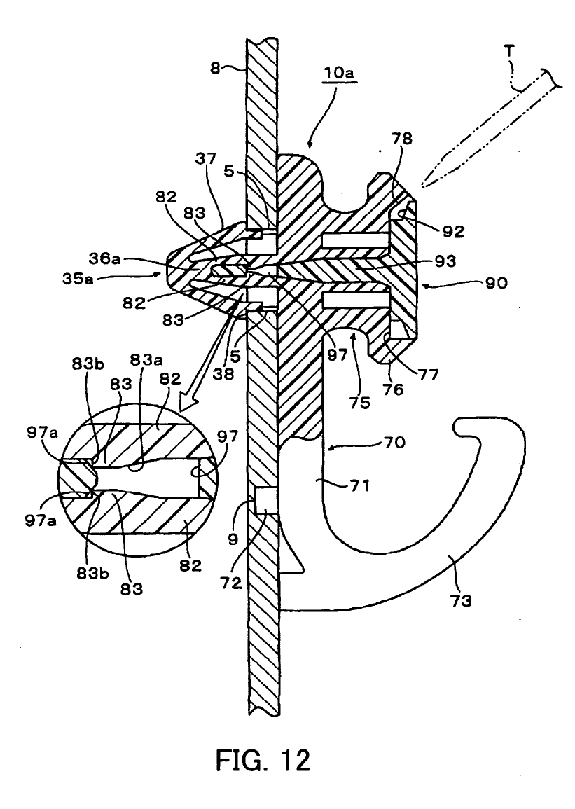

On the other hand, at the circular enlarged portion of the base portion 71, a cylindrical columnar portion 75 protrudes from the surface opposite to the surface from which the elastic leg portion 35a protrudes. Furthermore, the columnar portion 75 includes, at its tip end peripheral portion, an annular diameter expanded portion 76. Therefore, it is possible to hook a load-securing rope, net, etc., equipped in the luggage compartment, etc. At the tip end peripheral surface of the columnar portion 75, a circular dented portion 77 with a prescribed depth is formed, so that a cover plate 91 of the cap 90, which will be mentioned later, can be fitted therein. Furthermore, at the one upper part of the dented portion 77, a cut-out portion 78 is formed so as to extend obliquely toward the bottom of the dented portion 77. This cut-out portion 78 serves as an inserting portion for inserting a tool, such as, e.g., a minus driver, at the time of detaching the cap 90 from the main body 70 (see FIG. 12).

As shown in FIGS. 7 and 8B, when the column portion 75 is viewed from the axial direction, a pair of insertion holes 34 and 34 are formed almost in parallel at both sides of the column portion 75. Also, as shown in FIG. 8C, the pair of insertion holes 34 and 34 penetrate the columnar portion 75 and the base portion 71 from the bottom of the dented portion 77 of the tip end periphery of the columnar portion 75, and are located at both sides of a direction perpendicular to the bending direction A of the elastic leg portion 35a.

Furthermore, between the pair of insertion holes 34 and 34, a slit 79 connecting the insertion holes 34 and 34 is formed so as to extend in a direction perpendicular to them. More specifically, the slit 79 connects the pair of insertion holes 34 and 34 to form a substantially H-shape in cross-section when the columnar portion 75 and the base portion 74 are cut with a plane perpendicular to the axial direction and penetrates the columnar portion 75 and the base portion 71. Moreover, as shown in FIGS. 7 and 8B, this slit 79 is formed so as to cross the central portion of the columnar portion 75.

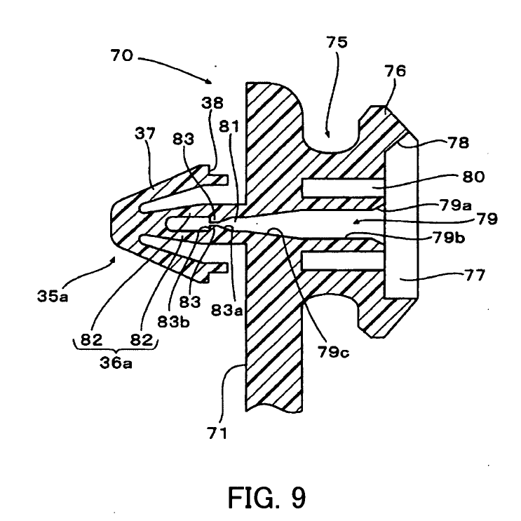

As shown in FIG. 9, this slit 79 has a first inner tapered surface 79a gradually decreased in diameter from the dented portion 77 of the columnar portion 75 toward the insertion direction of the cap 90, an inner straight surface 79b with a constant length extended from the tapered surface 79a, and a second inner tapered surface 79c gradually decreased in diameter from the straight surface 79b along the thickness direction of the base portion 71 and extended from the inner straight portion 79b. The first inner tapered surface 79a facilitates the insertion of the connection wall 93 of the cap 90 mentioned later, and the second inner tapered surface 79c decreases the clearance between this second tapered surface 79c and the tapered surface 95a of the rib 95 formed on the connection wall 93, which is mentioned later, to enhance the adhesiveness thereof. As shown in FIG. 9, above and below the slit 79 of the columnar portion 75, material released holes 80 and 80 with a prescribed depth are formed along the axial direction to prevent the occurrence of sink, etc., at the time of the forming.

The elastic leg portion 35a is explained with reference to FIG. 9. This elastic leg portion 35a is provided at one end portion of the base portion 71 and protruded from the side opposite to the columnar portion 75 as mentioned above. This elastic leg portion 35a protrudes from the opposed side portions of the opening edge portion of the slit 79 with a clearance 81 communicating with the slit 79, and has a stem portion 36a consisting of a pair of wall portions 82 and 82 connected at the tip end portions thereof. A connection wall 93 of the cap 90, which is mentioned later, is inserted in between the pair of wall portions 82 and 82 of the stem portion 36a. From the tip end both side portions of the stem portion 36a, a pair of engaging ledges 37 and 37 extend into an anchor shape.

At the longitudinal middle portion of the clearance 81 on the inner surfaces of the pair of wall portions 82 and 82 of the stem portion 36a, protruding portions 83 and 83 are provided in an opposed manner. The stepped portions 83b formed at the back side end portion of the clearance 81 of the protruded portion 83 are configured to engage with engaging holes 97 of the connection wall 93 of the cap 90 mentioned later. Moreover, each protruded portion 83 has a tapered surface 83a gradually decreased in height toward the base portion 71 to enhance the insertion of the connection wall 93. In this embodiment, the protruded portion 83 is formed at each wall portion 82 of the stem portion 36a, but can be formed at either one of them.

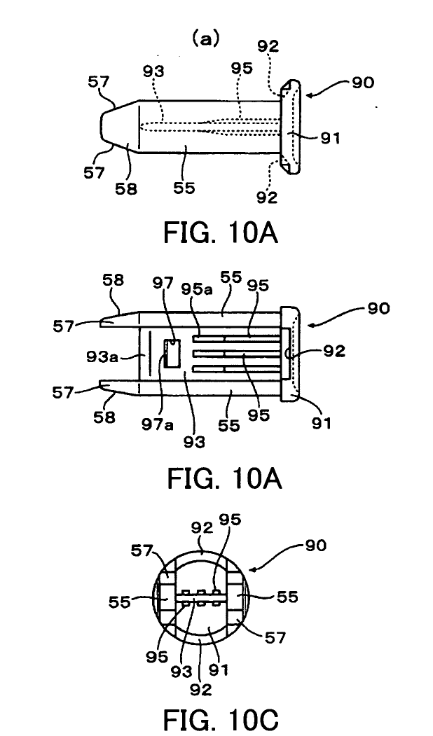

The cap 90 to be attached to the main body 70 mentioned above is explained with reference to FIGS. 7 and 10. This cap 90 has a cover plate 91 which can be fitted in the dented portion 77 of the columnar portion 75. From the opposed peripheral edge portions of the rear surface side of this cover plate 91, a pair of insertion ledges 55 and 55 to be inserted into the pair of insertion holes 34 and 34 of the main body 70 protrude in parallel with each other. Furthermore, as shown in FIG. 10C, at the opposed external peripheral edge portions between the pair of insertion ledge 55 and 55 at the rear surface side of the cover plate 91, obliquely cut grooved portions 92 and 92 with a predetermined width are formed to serve a minus driver insertion portion in combination with the cutout portion 78 of the main body 70 at the time of detaching the cap 90 from the main body 70 (see FIG. 12). At both the width direction sides of the tip end portion of each insertion ledge 55, a tapered surface 57 is formed, respectively (see FIG. 10A). Furthermore, at the outside surface of the longitudinal tip end portion of each insertion ledge 55, a tapered surface 58 is formed (see FIG. 10B). Thus, the insertion operation of the insertion ledges 55 and 55 into the insertion holes 34 and 34 of the main body 70 can be enhanced.

The pair of insertion ledges 55 and 55 are connected by a connection wall 93 having a predetermined length formed at the width direction intermediate portion into a generally H-shape as viewed from the axial direction. As a result, the connection wall 93 can be inserted into the slit 79 connecting the pair of insertion holes 34 and 34 in an H-shape in cross-section. The tip both sides of the connection wall 93 are formed into tapered surfaces 93a and 93a, for example, to enhance the insertion operation into the slit 79. On both surfaces of the connection wall 93, a plurality of ribs 95 with a predetermined length each extended in the longitudinal direction are formed at certain intervals. At the tip end portion of each rib 95, a tapered surface 95a is formed. Thus, the height at the tip end side is decreased.

The connecting wall 93 is provided with an engaging hole 97 to be engaged with the protruded portions 83 of the stem portion 36a at the front side of the tip end of each rib 96 at a predetermined distance. As shown FIG. 12, both the thickness direction side portions of the tip end side edge of the engaging hole 97 are formed into tapered surfaces 97a and 97a, respectively. The protruded portions 83 and 83 are engaged with these tapered surfaces 97a and 97a. The aforementioned engaging hole 97 and protruded portions 83 and 83 are served as an engaging portion in this embodiment.

Next, the steps of mounting the hook 10a as a part to the luggage compartment wall portion 8 as an mounting portion is explained using the mounting device.

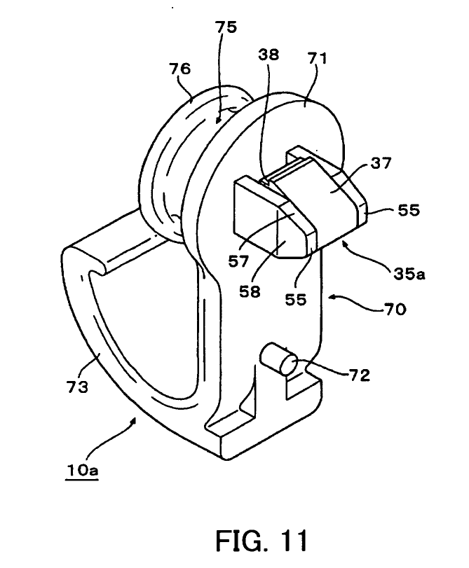

The cap 90 is pressed into the main body 70 until the insertion ledges 55 and 55 are positioned at both non-bending sides of the elastic leg portion 35a with the insertion ledges 55 and 55 of the cap 90 in alignment with the insertion holes 34 and 34 of the main body 70. As a result, the connection wall 93 of the cap 90 is inserted into the clearance 81 between the pair of wall portions 82 and 82 of the stem portion 36a via the slit 79 of the main body 70. As the cap 90 is further pushed, the tip end portion of the connection wall 93 presses the tapered surfaces 83a of the protruded portions 83 to bend the pair of wall portions 82 and 82 outwardly. When the engaging hole 97 reaches the stepped portions 83b of the protruded portions 83, the stepped portions 83b of the protruded portions 83 and 83 engage with the tapered surfaces 97a and 97a formed at the tip end side edge of the engaging hole 97. Thus, the cap 70 can be attached to the main body 70 in a pull-out prevented state as shown in FIG. 11.

Since the pair of insertion ledges 55 and 55 of the cap 90 are connected by the connection wall 93, the separation of the insertion ledges 55 and 55 will not occur. Furthermore, when the insertion ledges 55 and 55 are inserted in the insertion holes 34 of the main body 70, the insertion ledges 55 can be brought into contact with both non-bending sides of the elastic leg portion 35a. Consequently, at the time of inserting the elastic leg portions 35a and 35a and the insertion ledges 55 and 55 in the angular hole 4, each insertion ledge 55 can be prevented from getting stuck in the angular hole 4. Furthermore, since each insertion ledge 55 is difficult to bend, the mounting strength of the hook 10a to the luggage compartment wall portion 8 as an mounting portion can be enhanced.

Furthermore, the connection wall 93 of the cap 90 is inserted into the slit 79 formed so as to cross the central portion of the columnar portion 75, and the cover plate 91 of the cap 90 is fitted in the dented portion 77 of the columnar portion 75. In this state, the cover plate 91 is almost flush with the Up end of the columnar portion 75, and thus the end surface of the columnar portion 75 can be covered without protruding the cover plate 91 (see FIG. 12). In this way, the insertion ledges 55 and 55 and the connection wall 93 of the cap 90 are integrally combined with the columnar portion 75 of the main body 70, resulting in enhanced appearance.

After attaching the cap 90 to the main body 70 as mentioned above, the positioning pin 72 is inserted into the positioning hole 9 with the bending direction A of the elastic leg portion 35a facing to the long sides 5 and 5 of the angular hole 4. As a result, in the same manner as in the first embodiment, the elastic leg portion 35a passes through the angular hole 4 while being bent, and then engages with the inner periphery of the pair of long sides 5 and 5 at the rear side of the angular hole 4. Thus, the hook 10a is mounted on the luggage compartment wall portion 8 as an mounting portion.

On the other hand, in the case of detaching the hook 10a from the luggage compartment wall portion 8, as shown in FIG. 12, a tool T, such as, e.g., a minus driver, is inserted in between the cut-out portion 78 of the main body 70 and the grooved portion 92 of the cap 90 from the obliquely upward direction. Then, the periphery of the cap cover 91 of the cap 90 is lifted up by moving the tip end portion of the tool T like a lever, and then the cap 91 is pulled upward so as to be detached from the main body 70, to thereby disengage the engaging of the stepped portions 83b and 83b of the protruded portions 83 and the edges of the engaging hole 97. Thus, each insertion ledge 55 and the connection wall 93 of the gap 90 can be pulled out. When the cap 90 is pulled out from the main body 70, clearances are generated between the elastic leg portion 35a and the angular hole 4. Thus, as mentioned above, the main body 70 is rotated so that the bending direction of the elastic leg portion 35a faces the short side 6 of the angular hole 4, and then the elastic leg portion 35a is pulled out from the angular hole 4. As a result, the hook 10a can be removed from the luggage compartment wall portion 8.

At this time, in this embodiment, as shown in the enlarged cross-sectional view in FIG. 12, the protruded portions 83 and 83 are engaged with the tapered surfaces 97a of the engaging hole 97, respectively. Therefore, at the time of pulling out the cap 90 from the main body 70, each protruded portion 83 can be pressed smoothly to cause an easy outward bending of each wall portion 8, resulting in an easy detachment of the cap 90 from the main body 70.

As explained above, in this embodiment, it is configured such that the connection wall 93 of the cap 90 is inserted in the clearance 81 formed between the pair of wall portions 82 and 82 of the stem portion 36a to prevent the cap 90 from being pulled out by the engaging portion constituted by the protruded portions 83 formed between the pair of wall portions 82 and 82 and the engaging hole 97. Therefore, at the time of pulling out the cap 90 to detach the hook 10a, the connection wall 93 will be pulled out while being guided by the clearance 81 of the wall portions 82 and 82 of the stem portion 36a and the slit 79. Consequently, even in cases where the cap 90 is forcibly pulled out with large force by inserting the tool T, such as, e.g., a minus driver, in between the cut-out portion 78 and the clearance 92, only a load in the engaging direction (i.e., the direction of pushing the cap 90 into the main body 70, or the direction of pulling out the cap 90 from the main body 70) is applied to the engaging portion constituted by the protruded portions 83 and 83 and the engaging hole 97. Therefore, possible damages to the engaging portion can be prevented. Accordingly, the hook 10a can be again attached to the mounting portion, without requiring any exchange of the main body 70 and/or the cap 90.

Furthermore, in this embodiment, since the protruded portion 83 is formed on each wall portion 82 of the stem portion 36a at the longitudinal middle portion in the clearance 81, at the time of attaching or detaching the cap 90, each wall portion 82 of the stem portion 36a can be elastically bent to facilitate the attachment and detachment of the cap 90.

In this hook 10a mounted to the luggage compartment wall portion 8 as mentioned above, a rope, a net, etc., for securing a load in the luggage compartment can be hooked on the columnar portion 75, and a shopping bag, etc., can be hung on the hook portion 73, thereby improving the convenience.

In the aforementioned embodiment, a pair of insertion holes 34 and 34 are formed in the main body 70, and the cap 90 is provided with a pair of insertion ledges 55 and 55 to be disposed at both sides of the elastic leg portions 35a and 35a via the insertion holes 34 and 34. The present invention, however, allows the structure in which one insertion hole 34 and one insertion ledge 55 are formed and the insertion ledge is arranged only at one side of the elastic leg portion 35a.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

We claim:

1. A part mounting device for mounting a part to a generally rectangular angular hole formed in a mounting portion, comprising:
a main body having an elastic leg portion to be inserted in the angular hole and engaged with a pair of long sides of the angular hole and an insertion hole provided at at least non-bending side of the elastic leg portion;
a cap having an insertion ledge which is configured to come into contact with at least non-bending side of the elastic leg portion when inserted in the insertion hole, the insertion ledge being disposed in a clearance between the elastic leg portion and at least one short side of the angular hole in a state in which the elastic leg portion is engaged with a pair of long sides of the angular hole,
wherein the elastic leg portion is not engaged with the angular hole when the bending direction of the elastic leg portion is arranged in parallel to the long sides of the angular hole, and is engaged with the angular hole when the bending direction is arranged in parallel to the short sides of the angular hole.

2. The part mounting device as recited in claim 1, wherein the insertion hole of the main body is provided at both non-bending sides of the elastic leg portion, and wherein the cap is provided with a pair of generally parallel insertion ledges to be inserted in the pair of insertion holes.

3. The part mounting device as recited in claim 1, wherein the elastic leg portion has a stem portion upwardly protruded from the main body, and an engaging ledge extended from a tip of the stem portion toward the main body in an anchor shaped manner, and wherein the insertion ledge protrudes higher than the elastic leg portion when the cap is attached to the main body.

4. The part mounting device as recited in claim 2, wherein the elastic leg portion has a stem portion upwardly protruded from the main body, and a pair of engaging ledges extended from a tip of the stem portion toward the main body in an anchor shaped manner, and wherein the pair of insertion ledges protrude higher than the elastic leg portion when the cap is attached to the main body.

5. The part mounting device as recited in claim 4,
wherein the main body is provided with a pair of engaging grooves,
wherein the cap is provided with a pair of engaging ledges, and
wherein the pair of engaging ledges of the cap are engaged with the pair of engaging grooved in a state in which the cap is attached to the main body.

6. The part mounting device as recited in claim 1,
wherein the main body has a slit communicated with the insertion hole and penetrating the main body,
wherein the elastic leg portion has a stem portion including a pair of wall portions extended from opening edge portions of the slit via a clearance and connected at tip ends thereof, and engaging ledges protruded sideward from the stem portion,
wherein the cap has at least one insertion ledge to be inserted in the insertion hole of the main body, and a connection wall extended from the insertion ledge, the connection wall being to be inserted in the slit and a clearance between the wall portions of the stem portion, and
wherein an engaging portion for engaging the wall portions of the stem with the connection wall when the connection wall is inserted in the clearance of the wall portions of the stem portion is provided at an inner surface of the wall portion of the stem portion located at the clearance and the connection wall.

7. The part mounting device as recited in claim 6,
wherein the insertion holes of the main body are provided at both non-bending sides of the elastic leg portion,
wherein the slit connects the insertion holes in an H-shaped manner in cross-section, the slit penetrating the main body, and
wherein the cap has a pair of parallel insertion ledges to be inserted in the pair of insertion holes of the main body, and a connection wall which connects the insertion ledges, the connection wall being inserted in the slit and the clearance between the wall portions of the stem portion.

8. The part mounting device as recited in claim 6,
wherein the engaging portion includes protruded portions formed on inner surfaces of the wall portions of the stem portion facing the clearance of the wall portions at a longitudinal intermediate portion of the clearance, and an engaging hole formed in the connection wall of the cap, whereby the protruded portions are engaged with the engaging hole when the connection wall of the cap is inserted in the clearance of the wall portions of the stem portion.

9. The part mounting device as recited in claim 6,
wherein the engaging portion includes protruded portions formed on inner surfaces of the wall portions of the stem portion facing the clearance of the wall portions at a longitudinal intermediate portion of the clearance, and an engaging hole formed in the connection wall of the cap, whereby the protruded portions are engaged with the engaging hole when the connection wall of the cap is inserted in the clearance of the wall portions of the stem portion.

10. The part mounting device as recited in claim 1, wherein the main body has a holding portion for holding a shaft portion of a sun visor.

11. The part mounting device as recited in claim 6, wherein the main body has a holding portion for holding a shaft portion of a sun visor.

12. The part mounting device as recited in claim 1, wherein the main body has a columnar portion with a diameter expanded tip portion, and a hook extended from a vicinity of the columnar portion,
wherein insertion holes for inserting the insertion ledges are formed at both sides of the columnar portion,
wherein a slit is formed so as to cross a central portion of the columnar portion, and
wherein the cap is inserted along an axis of the columnar portion and put on an end of the columnar portion.
